(19) United States
(12) Patent Application Publication
(10) Pub. No.: US 2003/0163819 A1
(43) Pub. Date: Aug. 28, 2003

(54) Video-audio multimedia web-mail system and send-receive method thereof

(76) Inventors: Ching-Sung Lee, Tao Yuan Hsien (TW); Mu-Hsiu Hsu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,813

(22) Filed: Feb. 21, 2003

(30) Foreign Application Priority Data
Feb. 22, 2002 (TW) 91103104

(51) Int. Cl. G06F 3/00; H04N 5/445; G06F 13/00; H04N 7/173; H04N 7/16; G06F 15/16

(52) U.S. Cl. 725/61; 725/112; 725/109; 725/135; 709/217; 709/219

(57) ABSTRACT

A video-audio multimedia web-mail system, comprising a wide area network, a user side and a server side. In the user side, an editor is used to edit the e-mail, and the e-mail comprises a multimedia information. The browser has a plug-in program, the plug-in program is used to link the editor and to send out the e-mail via the wide area network. In the server side, a web server is used to receive the e-mail sent by the plug-in program via the wide area network, and display the e-mail having a web page language format on a web page that is executed by it. The application server has a parse and transform program, the parse and transform program is used to parse the e-mail that is received by the web server, and transform the e-mail to the web page language format based on the parsing result, send out the e-mail having the web page language format to the web server, and transform the e-mail having the web page language format to make it comply with both the web page language format and the coding specification of Multipurpose Internet Mail Extension (MIME), and send out an e-mail that complies with both the web page language format and the coding specification of MIME to a mail server in the system. The video-audio server sends a video-audio file that is contained in the e-mail received by the web server to the browser via the wide area network.

### CROSS REFERENCE TO RELATED APPLICATIONS

This application claims the priority benefit of Taiwan application serial no. 91103104, filed Feb. 22, 2002.

### Background of Invention

1. Field of Invention

The present invention generally relates to a web-mail system, and more particularly, to a web-mail system that supports the video-audio multimedia.

2. Description of Related Art

Electronic mail (e-mail) is one kind of media that is currently in wide use on the Internet for exchanging information. By using electronic mail, information is easily transferred from one side of Internet to the other.

The send-receive method of e-mail is not limited by only using the e-mail send-receive software, the web page of the electronic mailbox is also provided on the Internet URL (Uniform Resource Locator) to perform the e-mail send-receive operation. The electronic mailbox is provided by the system that provides the e-mail send-receive service, and this system is the so-called web-mail system.

The advantage of the web-mail system is that the user can perform e-mail send-receive operation via the mailbox as long as the user has access to a URL that corresponds to one electronic mailbox of the web-mail system, without needing to install additional e-mail send-receive software, and also avoid the complex setting that is needed when installing the e-mail software. In recent years, since the broadband network gradually has replaced the narrowband dial-up, when the user enters into the web-mail system and edits the e-mail, it is common for the user to attach some multimedia files to the e-mail, or edit the e-mail as the video-audio multimedia e-mail with personal favors, such as attaching a personal picture onto the text of the e-mail, or attaching a special signature file, or even attaching a personal video file.

With regard to the users, when editing a video-audio multimedia e-mail, the user has to use the text edit software to edit the video-audio multimedia e-mail via the multilink. The edited-video-audio multimedia e-mail does not always comply with the web page language format and the coding specification of Multipurpose Internet Mail Extension (abbreviated as MIME hereinafter) that is commonly used currently when transmitting an e-mail. Therefore, when the video-audio multimedia e-mail sent from the web-mail system by the sender does not support the web page language format of the commonly used web-mail system, it may result in the problem that the receiver cannot see the whole video-audio multimedia e-mail on the general web-mail system. Moreover, when the web-mail system sends out the video-audio multimedia e-mail through the mail server, if the coding specification of the video-audio multimedia e-mail does not comply with the coding specification of MIME, the text of the received video-audio multimedia e-mail may become scrabbled. Therefore, it is quite inconvenient and heavily annoying to the users of the web-mail system.

### SUMMARY OF THE INVENTION

Therefore, the present invention provides a web-mail system that supports the video-audio multimedia e-mail. The fact that user can edit the video-audio multimedia e-mail only via the multiple hyperlink can be avoided by only using the browser, and the present invention is able to send out the video-audio multimedia e-mail without having to worry about the problem that the e-mail does not comply with the web page language format and the coding specification of the transmission mode of the multimedia mail. Moreover, the receiver is able to see the whole video-audio multimedia e-mail.

The present invention provides a multimedia web-mail system, comprising a wide area network, a user side, and a server side. Wherein, the user side comprises an editor and a browser. The server side comprises a web server and an application server. The editor is used to edit the e-mail, and the e-mail comprises a multimedia information. The browser has a plug-in program that is used to link the editor and send out the e-mail via the wide area network. The web server is used to receive the e-mail that is sent from the plug-in program via the wide area network, and display the e-mail having the web page language format on the web page that is executed by it. The application server has a parse and transform program, the parse and transform program is used to parse the e-mail that is received by the web server, transform the e-mail into the web page language format based on a parsing result, send out the e-mail having the web page language format to the web server, and transform the e-mail having the web page language format to make it comply with both the web page language format and the coding specification of MIME, so that the e-mail, having a format that complies with both the web page language format and the coding specification of MIME, can be sent to the mail server of the web-mail system.

The present invention further provides a video-audio multimedia web-mail system. Besides the multimedia information in the e-mail, the system further processes the video-audio information. The system comprises a wide area network, a user side, and a server side. Wherein, the user side comprises an editor and a browser. The server side in addition to comprising a web server and an application server, further comprises a video-audio server. Wherein, the function and the interconnection relationship of the wide area network, the editor, the browser, the web server, and the application server are the same as the ones in the wide area network, the editor, the browser, the web server, and the application server of the multimedia web-mail system proposed by the present invention mentioned above. The video-audio server is used to send the video-audio information that is contained in the e-mail received from the web server via the wide area network to the browser.

The present invention provides a send-receive method for the video-audio multimedia web-mail, the method is used in the user side to upload the e-mail. The method comprises linking a web-mail edit program to an edit window; and uploading the e-mail that finishes the edit in the edit window. Wherein, the e-mail comprises a video-audio information and a multimedia information.

The present invention provides a send-receive method for multimedia web-mail, the method is used in the server side to process the e-mail. The method comprises parsing the received e-mail and determining whether it is a web page language format, wherein the e-mail comprises a multimedia information; transforming the e-mail into the web page language format based on a parsing result; and transforming the e-mail having the web page language format to make it comply with both the web page language format and the coding specification of MIME.

The present invention further provides a send-receive method for the video-audio multimedia web-mail, the method is used in the user side and the server side to process the e-mail. The method comprises linking a web-mail send-receive program to an edit window; uploading the e-mail that finishes the edit in the edit window, wherein the e-mail comprises a video-audio information and a multimedia information; parsing the received e-mail and determining whether it is a web page language format; transforming the received e-mail into the web page language format based on a parsing result; and transforming the e-mail having the web page language format to make it comply with both the web page language format and the coding specification of MIME; and sending out the video-audio information in the e-mail.

### Brief Description of Drawings

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows an operation flow chart for editing and sending the web-mail system video-audio multimedia e-mail in the preferred embodiment according to the present invention;

FIG. 2 schematically shows an operation flow chart for reading the received web-mail system video-audio multimedia e-mail in the preferred embodiment according to the present invention;

FIG. 3 schematically shows an operation flow chart for forwarding the received web-mail system video-audio multimedia e-mail in the preferred embodiment according to the present invention; and

FIG. 4 schematically shows a flow chart of the method for sending and receiving web-mail in the preferred embodiment according to the present invention.

### DETAILED DESCRIPTION

The present invention provides a web-mail system that can be used on a personal user side such as the personal computer, the personal digital assistant (PAD), the third generation mobile phone, or the set-top box. The objective of the present invention is to allow the user on the user side to use a web browser such as Microsoft Internet Explorer (IE) or Netscape browser and the text edit software such as Microsoft Word text editor to send-receive e-mail when connecting to a specific URL via the network by using a browser. The user uses the browser to edit the video-audio multimedia e-mail without the help of the hypertext text edit software. The key point is after the user finishes editing the video-audio multimedia e-mail, the video-audio multimedia e-mail does not need to be transformed to make it support and comply with the web page language format and the coding specification of MIME anymore.

The video-audio multimedia e-mail system in the preferred embodiment according to the present invention comprises a user side and a server side. The user side comprises a browser and an editor. The server side comprises a web server, an application server, a database server and a video-audio server. Wherein, the browser has a plug-in program, and the application server has a parse and transform program that is composed of an object oriented programming design language (such as C#).

When the user enters into this system's web page that is open to the public via the wide area network by using the browser, the system will download the plug-in program mentioned above and plug it into the browser automatically. It is obvious that the system will not perform the download operation if the user has installed and plugged in the plug-in program onto the browser already.

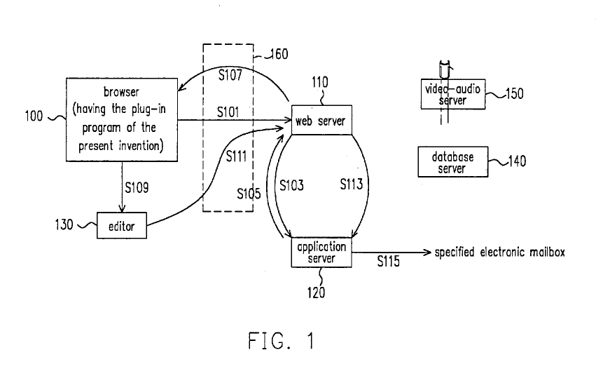

The system's mailbox user enters into the web page by using the browser having the plug-in program and clicks the edit new e-mail option that is provided by the web page. FIG. 1 schematically shows a system operation flow chart when the user edits and sends out e-mail using this system. In step S101, the operation corresponding to the browser 100 issues a request for editing the new e-mail into the web server 100. In step S103, the web server 110 receives the request for editing the new e-mail and activates the application server 120 to start its operation. In step S105, after the application server is ready to start its operation, the application server 120 replies with the information “The application server 120 is ready to start its operation” to the web server 110. That is, to inform the web server 110 that the application server 120 is ready to start its operation now.

After the web server 110 receives the response from the application server 120, the web server 110 further replies with the information “The application server 120 is ready to start its operation” to the browser 100 to drive the plug-in program linking to the editor 130 that is used to edit the video-audio multimedia e-mail to provide the user the facility to edit the video-audio multimedia e-mail. Wherein, the editor 130 can be a text edit software such as Word mentioned above. In the preferred embodiment, the plug-in program provides a window screen for linking to the editor 130. User can directly use the “Object insert” link option in the editor 130 via this window screen, so that the user can insert the audio or video file into the e-mail, step S109. Therefore, by using the link option provided by the window screen, the user can easily edit the video-audio multimedia e-mail.

When the user finishes editing the video-audio multimedia e-mail in the window screen and clicks the option of send e-mail that is provided by the window screen, the plug-in program sends out the video-audio multimedia e-mail to the web server 110 with the standard file format, for example, the Word text edit software using the .doc file, step S111. By using the link option provided by the window screen, the user can upload the edited video-audio multimedia e-mail without the help of the multilink.

After the web server 120 receives the edited video-audio multimedia e-mail that is sent out by the plug-in program 130, the web server 110 subsequently sends the edited video-audio multimedia e-mail that is received by the plug-in program 130 to the application server 120, step S113.

After the application server 120 receives the edited video-audio multimedia e-mail, at first the application server 120 parses and determines whether the edited video-audio multimedia e-mail complies with the web page language format by using its built-in parse and transform program. If the edited video-audio multimedia e-mail complies with the web page language format, the application server 120 directly transforms the edited video-audio multimedia e-mail to make it comply with both the web page language format and the coding specification of MIME, and also sends out the e-mail that complies with both the web page language format and the coding specification of MIME to the mail server that serves as the electronic mailbox used by the user in the system, and finally sends the video-audio multimedia e-mail to the electronic mailbox that is specified by the user via the mail server. If the edited video-audio multimedia e-mail does not comply with the web page language format, the application server 120 transforms the edited video-audio multimedia e-mail to comply with the web page language format by using the built-in parse and transform program, and further transforms the edited and transformed video-audio multimedia e-mail that complies with the web page language format to make it comply with both the web page language format and the coding specification of MIME, and also sends out the e-mail that complies with both the web page language format and the coding specification of MIME to the mail server that serves the electronic mailbox used by the user in the system, and finally sends the video-audio multimedia e-mail to the electronic mailbox that is specified by the user via the mail server, step S115.

Complying with the web page language format mentioned above means complying with the language format that is currently used for Internet web pages, such as the format of the Hypertext Markup Language (HTML) or the Extensible Markup Language (XML). These two languages are the two mainly used in the commonly used web page that is configured on the web server 110. HTML is exemplified here, if the .doc file used by the Word text edit software intends to comply with the HTML format, the equations, tables, and pictures in the .doc file must be transformed to the specific format as shown in Table 1.

TABLE 1

| Word (.doc file) | Format specificd by HTML |
|---|---|
| Equation | Gif file |
| Table | Gif file |
| Picture | Gif file |
| Text | Text file (text font and format may be |
| | reserved) |
| Audio | Such as WMA file |
| Video or Film | Such as WMV file |

Therefore, the video-audio multimedia e-mail that is transformed to the HTML or XML format will definitely comply with the web page language format that is supported by the web server of other web-mails.

Furthermore, the video-audio multimedia e-mail also complies with the coding specification defined by the mail server on Internet, the video-audio multimedia e-mail can be sent intact to the electronic mailbox specified by the user via the mail server. The scrabbled text that happens in the video-audio multimedia e-mail after receiving the video-audio multimedia e-mail can be avoided.

Therefore, via the step S101 through S115, when the user sends the video-audio multimedia e-mail to the electronic mailbox specified by the user, the user of the specified electronic mailbox can perfectly read the video-audio multimedia e-mail by using the e-mail send-receive software of the web-mail system that provides the specified electronic mailbox.

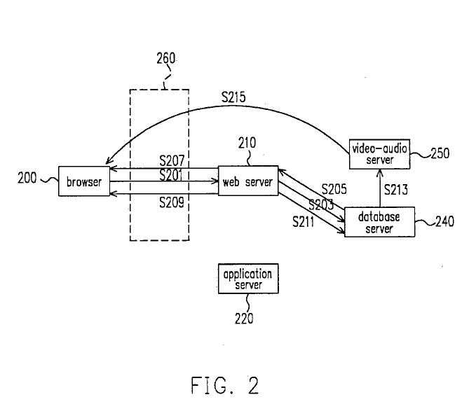

When the user intends to use this system to read the received video-audio multimedia e-mail in the electronic mailbox used by the user, referring to FIG. 2, the user enters into the web page that is open to the public via the wide area network by using the browser, and clicks one of the reading the video-audio multimedia e-mail options provided by the web page. Similarly, the browser 200 will send out a specified request for reading the video-audio multimedia e-mail to the web server 210, step S201.

When the web server 210 receives the specified request for reading the video-audio multimedia e-mail, the web server 210 will inform the database server 240 to send out the video-audio multimedia e-mail that corresponds to the specified request of reading the video-audio multimedia e-mail according to the specified request of reading the video-audio multimedia e-mail, step S203.

When the database server 240 receives the notification of “sending out the video-audio multimedia e-mail that corresponds to the specified request of reading the video-audio multimedia e-mail” sent by the web server 210, the database server 240 searches for the video-audio multimedia e-mail that corresponds to the specified request for reading the video-audio multimedia e-mail from its own database, and sends the corresponding video-audio multimedia e-mail to the web server 210, step S205. After the web server 210 receives the corresponding video-audio multimedia e-mail that is sent by the database server 240, the web server 210 further sends the corresponding video-audio multimedia e-mail to the browser 200, step S207.

By using step S207, the system user can read the video-audio multimedia e-mail.

When the system user reads the video-audio multimedia e-mail, and intends to read the video-audio file that is contained in the video-audio multimedia e-mail, the user clicks the hyperlink option of the video-audio file in the video-audio multimedia e-mail. Similarly, the browser 200 will send out a specified request of reading the video-audio file to the web server 210, this is step S209.

When the web server 21 0 receives the specified request of reading the video-audio file, the web server 210 will notify the database server 240 to send out the video-audio file corresponding to the specified request of reading the video-audio file according to the specified request of reading the video-audio file, this is step S211.

When the database server 240 receives the notification of “sending out the video-audio file that corresponds to the specified request of reading the video-audio file” sent by the web server 210, the database server 240 searches for the video-audio file that corresponds to the specified request of reading the video-audio file from its own database, and sends the corresponding video-audio file to the video-audio server 250, step S213. After the video-audio server 250 receives the corresponding video-audio file that is sent by the database server 240, the video-audio server 250 further sends the video-audio file to the browser 200 for playing by using the direct or stream method, step S217. In the present embodiment, the stream method is used to send the video-audio file to the browser 200.

By using step S215, the system user can enjoy the audio or video effect brought by the video-audio file that is contained in the video-audio multimedia e-mail while reading the video-audio multimedia e-mail. Of course, the system can be designed to automatically send out the multimedia file that is contained in the multimedia e-mail to the browser 200 to play when the user is reading the video-audio multimedia e-mail. That is, the step S215 runs at the same time while step S207 is running.

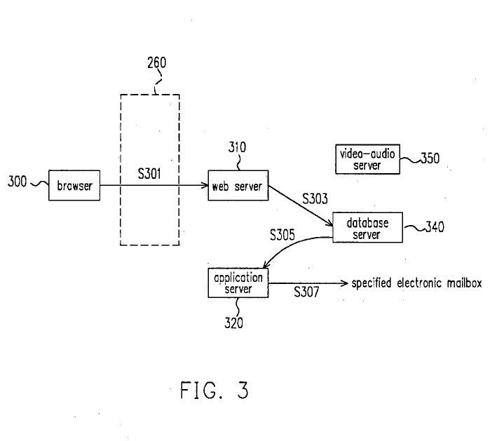

For when the user intends to use the system to forward the received video-audio multimedia e-mail that is stored in the electronic mailbox of the system used by the user, refer to FIG. 3. FIG. 3 schematically shows an operation flow chart for forwarding the received web-mail system video-audio multimedia e-mail in the preferred embodiment according to the present invention. The user opens the browser for entering into the web page that is open to the public via the wide area network, highlights one of the video-audio multimedia e-mails, and clicks the forwarding option provided by the system. Similarly, the browser 300 will send out a specified request for forwarding the video-audio multimedia e-mail to the web server 310, step S301.

When the web server 310 receives the specified request for forwarding the video-audio multimedia e-mail, the web server 310 will notify the database server 340 to send out the video-audio multimedia e-mail corresponding to the specified request for forwarding the video-audio multimedia e-mail according to the specified request of forwarding the video-audio multimedia e-mail, step S303.

When the database server 340 receives the notification “sending out the video-audio multimedia e-mail corresponding to the specified request for forwarding the video-audio multimedia e-mail” sent by the web server 310, the database server 340 searches the video-audio multimedia e-mail corresponding to the specified request of forwarding the video-audio multimedia e-mail from its own database, and sends the corresponding video-audio multimedia e-mail to the application server 320, step S305.

When the application server 320 receives the corresponding video-audio multimedia e-mail, at first the application server 320 parses and determines whether the corresponding video-audio multimedia e-mail complies with the web page language format by using its built-in parse and transform program. If the edited video-audio multimedia e-mail complies with the web page language format, the application server 320 directly transforms the corresponding video-audio multimedia e-mail to make it comply with both the web page language format and the coding specification of MIME, and also sends out the corresponding e-mail that complies with both the web page language format and the coding specification of MIME to the mail server that serves as the electronic mailbox used by the user in the system, and finally sends the video-audio multimedia e-mail to the electronic mailbox that is specified by the user via the mail server. If the edited video-audio multimedia e-mail does not comply with the web page language format, the application server 320 transforms the edited video-audio multimedia e-mail to comply with the web page language format by using its built-in parse and transform program, and further transforms the edited and transformed video-audio multimedia e-mail that complies with the web page language format to make it comply with both the web page language format and the coding specification of MIME, and also sends out the e-mail that complies with both the web page language format and the coding specification of MIME to the mail server that serves as the electronic mailbox used by the user in the system, and finally sends the video-audio multimedia e-mail to the electronic mailbox that is specified by the user via the mail server, step S307.

To be noted, the web server such as the IIS server or the Apache server can be chosen as the web server 110, 210 in the present invention. However, since the Apache server is free, the web server 110, 210 in the present invention chooses to use the Apache server. The application servers such as the WebLogic server, the WebSphere server, the iPlanet server, the Tomcat server, or the J-Boss server can be chosen as the application server 120, 220 in the present invention. Similarly, based on the cost consideration, the application server 120, 220 of the present invention chooses to use the Tomcat server in the preferred embodiment of the present invention. The database server such as the SQL server, the Oracle server, or the DB2 server can be chosen as the database server 140, 240 in the present invention. Similarly, based on the cost consideration, the database server 140, 240 in the present invention chooses to use the Oracle server in the preferred embodiment of the present invention.

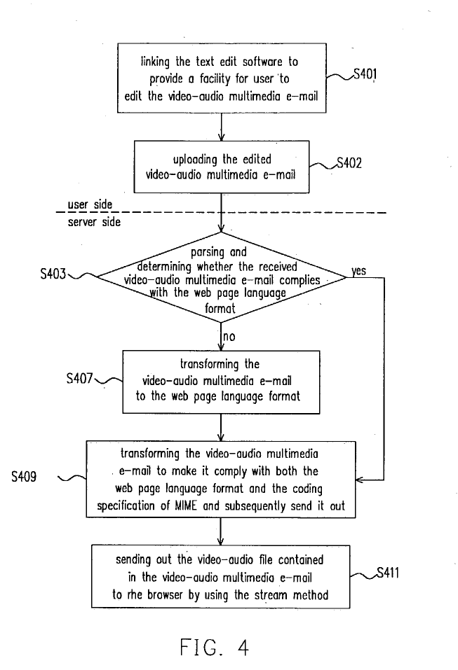

Furthermore, the present invention further provides a method for sending and receiving e-mail on both the user side and the server side. FIG. 4 schematically shows a flow chart of the method for sending and receiving web-mail in the preferred embodiment according to the present invention.

When the user opens the browser on the user side having the browser and the text editing software to send an e-mail to the server side of the web-mail system via the wide area network, a text editing software is linked to provide the user with a facility for editing the e-mail, this is step S401. Afterwards, the edited e-mail is uploaded to the server side, wherein the e-mail comprises the video-audio information and the multimedia information, step 5402.

The server side then parses and determines whether the received video-audio multimedia e-mail is in the web page language format, step S403.

If the received video-audio multimedia e-mail is in the web page language format, before the web server sends out the received video-audio multimedia e-mail, the video-audio multimedia e-mail is transformed to comply with both the web page language format and the coding specification of MIME and subsequently sent out, step S409.

If the received video-audio multimedia e-mail is not web page language format, the video-audio multimedia e-mail is transformed to the web page language format, step S407. Before the web server sends out the transformed video-audio multimedia e-mail having the web page language format, the video-audio multimedia e-mail is transformed to make it comply with both the web page language format and the coding specification of MIME and subsequently sent out, step S409.

When the user opens the browser and via the wide area network reads the video-audio file that is contained in the video-audio multimedia e-mail of the web-mail system, the video-audio file contained in the video-audio multimedia e-mail is sent out to the browser for playing by using the streaming method, step S411.

In summary, the present invention provides a web-mail system that can be used in the personal computer, the personal digital assistant, and the third generation mobile phone. Wherein, the editor hyperlink text edit software provides a facility for the user to easily edit the video-audio multimedia e-mail. The parse and edit program that is built-in the dynamic application server transforms the edited video-audio multimedia e-mail to make it comply with both the web page language format this is commonly used in the Internet and the coding specification that is commonly used in the mail server. Therefore, the user does not have to worry about whether the web server in the web-mail system supports the file format of the e-mail, and also eliminates the occurrence of the scrabbled code that happens in e-mail text. Therefore, the present invention provides an easy environment for the user to use video-audio multimedia e-mail, and further provides the best communication channel between teachers and students, enterprises and customers, and managers and staffs.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A video-audio multimedia web-mail system, comprising:
a wide area network;
a user side, comprising:
an editor, used to edit an electronic mail (e-mail), wherein, the e-mail comprises a video-audio information and a multimedia information;
a browser, having a plug-in program, wherein, the plug-in program is used to link the editor and send out the e-mail via the wide area network;
a server side, comprising:
a web server, used to receive the e-mail that is sent by the plug-in program via the wide area network, and display the e-mail having a web page language format on a web page that is executed by itself;
an application server, having a parse and transform program, wherein, the parse and transform program parses the e-mail that is received by the web server, transforms the e-mail to the web page language format based on the parsing result, sends out the e-mail having the web page language format to the web server, and transforms the e-mail having the web page language format to make it comply with both the web page language format and a coding specification of Multipurpose Internet Mail Extension (MIME), and sends the e-mail having the web page language format and the coding specification of MIME to a web server; and
a video-audio server, used to send out the video-audio information that is contained in the e-mail received by the web server via the wide area network to the browser.

2. The video-audio multimedia web-mail system of claim 1, wherein the user side can be one of a personal computer user side, a personal digital assistant (PDA) user side, a set-top box user side, and a third generation mobile phone user side.

3. The video-audio multimedia web-mail system of claim 1, wherein the editor is a text edit software.

4. The video-audio multimedia web-mail system of claim 1, wherein the web page language format is a Hypertext Markup Language (HTML) format.

5. The video-audio multimedia web-mail system of claim 1, wherein the web page language format is an Extensible Markup Language (XML) format.

6. The video-audio multimedia web-mail system of claim 1, wherein the application server comprises:
a database server, used to store and send out the e-mail having the web page language format to the web server and the video-audio server.

7. A multimedia web-mail system, comprising:
a wide area network;
a user side, comprising:
an editor, used to edit an electronic mail (e-mail), wherein, the e-mail comprises a multimedia information;
a browser, having a plug-in program, wherein, the plug-in program is used to link the editor and send out the e-mail via the wide area network;
a server side, comprising:
a web server, used to receive the e-mail that is sent by the plug-in program via the wide area network, and display the e-mail having a web page language format on a web page that is executed by itself; and
an application server, having a parse and transform program, wherein, the parse and transform program parses the e-mail that is received by the web server, transforms the e-mail to the web page language format based on the parsing result, sends out the e-mail having the web page language format to the web server, and transforms the e-mail having the web page language format to make it comply with both the web page language format and a coding specification of Multipurpose Internet Mail Extension (MIME), and sends the e-mail having the web page language format and the coding specification of MIME to a web server; and
a video-audio server, used to send out the video-audio information that is contained in the e-mail received by the web server via the wide area network to the browser.

8. The multimedia web-mail system of claim 7, wherein the user side can be one of a personal computer user side, a personal digital assistant (PDA) user side, a set-top box user side, and a third generation mobile phone user side.

9. The multimedia web-mail system of claim 7, wherein the editor comprises:
a text edit software, used to edit the e-mail information.

10. The multimedia web-mail system of claim 7, wherein the web page language format is a Hypertext Markup Language (HTML) format.

11. The multimedia web-mail system of claim 7, wherein the web page language format is an Extensible Markup Language (XML) format.

12. A video-audio multimedia web-mail send-receive method, related to a method for uploading an e-mail on a user side, the method comprising:
linking a web-mail edit program to an edit window; and
uploading the e-mail to finish the editing in the edit window, wherein, the e-mail comprises a video-audio information and a multimedia information.

13. The video-audio multimedia web-mail send-receive method of claim 12, wherein the user side can be one of a personal computer user side, a personal digital assistant (PDA) user side, a set-top box user side, and a third generation mobile phone user side.

14. The video-audio multimedia web-mail send-receive method of claim 12, wherein the edit window can be provided by a text processing software.

15. A multimedia web-mail send-receive method, related to a method for processing an e-mail on a server side, the method comprising:
parsing and determining whether the received e-mail is a web page language format, wherein, the e-mail comprises a multimedia information;
transforming the e-mail having the web page language format based on a result after the parsing; and
transforming the e-mail having the web page language format to make it comply with both the web page language format and a coding specification of MIME.

16. The multimedia web-mail send-receive method of claim 15, wherein the web page language format is a Hypertext Markup Language (HTML) format.

17. The multimedia web-mail send-receive method of claim 15, wherein the web page language format is an Extensible Markup Language (XML) format.

18. The multimedia web-mail send-receive method of claim 16, wherein the method further comprises:
transforming an equation information in the e-mail to a graphics exchange format file.

19. The multimedia web-mail send-receive method of claim 16, wherein the method further comprises:
transforming a table information in the e-mail to a graphics exchange format file.

20. The multimedia web-mail send-receive method of claim 16, wherein the method further comprises:
transforming a picture information in the e-mail to a graphics exchange format file.

21. The multimedia web-mail send-receive method of claim 16, wherein the method further comprises:
transforming a spreadsheet information in the e-mail to a graphics exchange format file.

22. A video-audio multimedia web-mail send-receive method, used on a user side and a server side to process an e-mail, the method comprising:
linking a web-mail edit program to an edit window;
uploading the e-mail to finish the editing in the edit window, wherein, the e-mail mail comprises a multimedia information and a video-audio information; and
sending out the video-audio information in the e-mail.

23. The video-audio multimedia web-mail send-receive method of claim 22, wherein the method further comprises:
sending out the video-audio information in the e-mail to the browser with a streaming method.

24. The video-audio multimedia web-mail send-receive method of claim 22, wherein the user side can be one of a personal computer user side, a personal digital assistant (PDA) user side, a set-top box user side, and a third generation mobile phone user side.

25. The video-audio multimedia web-mail send-receive method of claim 22, the method further comprising:
opening an edit window that is linked to the text edit software via the web-mail edit program.

26. The video-audio multimedia web-mail send-receive method of claim 22, wherein the web page language format is a Hypertext Markup Language (HTML) format.

27. The video-audio multimedia web-mail send-receive method of claim 22, wherein the web page language format is an Extensible Markup Language (XML) format.

28. The video-audio multimedia web-mail send-receive method of claim 22, wherein the multimedia information comprises an equation, a table information, a picture information, and a spreadsheet information.

29. The video-audio multimedia web-mail send-receive method of claim 28, wherein the method further comprises:
transforming an equation information in the e-mail to a graphics exchange format file.

30. The video-audio multimedia web-mail send-receive method of claim 28, wherein the method further comprises:
transforming a table information in the e-mail to a graphics exchange format file.

31. The video-audio multimedia web-mail send-receive method of claim 28, wherein the method further comprises:
transforming a picture information in the e-mail to a graphics exchange format file.

32. The video-audio multimedia web-mail send-receive method of claim 28, wherein the method further comprises:
transforming a spreadsheet information in the e-mail to a graphics exchange format file.
